(19) United States
(12) Patent Application Publication
(10) Pub. No.: US 2013/0133557 A1
(43) Pub. Date: May 30, 2013

(54) PALLET AND METHOD FOR MANUFACTURING THE SAME

(71) Applicant: Toyohiro YOSHINAGA, WANCHAI (HK)

(72) Inventor: Toyohiro YOSHINAGA, WANCHAI (HK)

(73) Assignee: NEW STYLE PACKAGE HK LIMITED, WANCHAI (HK)

(21) Appl. No.: 13/603,417

(22) Filed: Sep. 5, 2012

(30) Foreign Application Priority Data
Nov. 25, 2011 (CN) 201110381772.0

(51) Int. Cl. B65D 19/18; B29C 65/70

(52) U.S. Cl. 108/57.25; 264/45.4

(57) ABSTRACT

A method for manufacturing a pallet includes the following steps: (a) preparing a bottom case and a top cover respectively; (b) positioning the bottom case and top cover into a mould of an EPS foams molding machine, closing the mould and filling the mould cavity with EPS beads; (c) heating to make the EPS beads expand to form an inner core which is fused with the bottom case or top cover and then doing a cooling process; (d) opening the mould, positioning the top cover or bottom case onto the bottom case or top cover and closing the mould, heating to make the EPS beads expand again to be fused with the top cover or bottom case, and then doing a cooling process; and (e) demolding to produce a pallet. The outer casing and inner core of the pallet has good bond strength, thereby ensuring the quality of pallet.

### BACKGROUND OF THE INVENTION

The present invention relates to shipping containers and methods for manufacturing the same, and more particularly to a method for manufacturing a pallet and a pallet made by this method.

To transport goods more effectively, generally use a pallet to bearing the goods so as to use a forklift to carry or load and unload the goods. A traditional pallet, which is a woody pallet made of wood, exists disadvantages of easy to become damp, easy to be damaged by worms and not environmental, thus it is being displaced by a plastic pallet step by step. A conventional plastic pallet is made of plastic materials by one-step injection molding; for example, a utility model published on Apr. 5, 2006 by SIPO with a patent number of ZL20052002995.6 discloses a plastic pallet made of high-density polyethylene (HDPE) by one-step injection molding. The plastic pallet made of such materials has defects of poor environmental stress crack resistance and poor heat aging properties.

A patent application published on Mar. 9, 2011 by SIPO with an application number of 201010502168.4 discloses a aviation pallet and a method for manufacturing the same, which including steps of: mould pressing EPS foams to form an EPS board with supporting pillars; next, fixing a PET film attached with an EVA glue layer onto the surface of the EPS board; and then absorbing to form vacuum between the PET film and EPS board by a vacuum plastic-absorbing machine and utilizing atmospheric pressure to make the PET film be pasted with the EPS board via EVA glue layer tightly. Compared with the plastic pallet made of high-density polyethylene (HDPE) by one-step injection molding, its EPS board as an inner core has characteristics of light in weight and good heat insulation effect, and its PET film as an outer casing has good mechanical property which can overcome the shortage of poor impact and pull resistance of the EPS board therein, thereby the pallet has an advantage of light in weight and has good mechanical property such as good impact and pull resistance and so on. However, in the structure of this pallet, the PET film is pasted onto the outer surface of the EPS board via the EVA glue layer by vacuum forming, thus, in a comparative hostile environment, it is easy to cause the inner core be separated from the outer casing, thereby reducing the impact strength of the pallet and increasing the possibility of breakage and broken of the pallet when using.

### BRIEF SUMMARY OF THE INVENTION

One technical problem that the present invention wants to solve is that an inner core and an outer casing of a pallet made by existing manufacturing method of pallet are easy to detach from each other. In view of the above, the present invention provides a method for manufacturing a pallet and a pallet manufactured by this manufacturing method. The inner core and outer casing of the pallet manufactured by this manufacturing method can combine with each other well thus will not detach from each other easily.

To solve above technical problem, the present invention provides a method for manufacturing a pallet, which includes the following steps: (a) preparing a bottom case and a top cover respectively; (b) positioning the bottom case and top cover into a mould of an EPS foams molding machine, closing the mould and filling a mould cavity of the mould with EPS beads; (c) heating to make the EPS beads expand to form an inner core which is fused with the bottom case or top cover and then doing a cooling process; (d) opening the mould, positioning the top cover or bottom case onto the bottom case or top cover and closing the mould, heating to make the EPS beads expand again to be fused with the top cover or bottom case, and then doing a cooling process; and (e) demolding to produce a pallet.

In above method, the EPS beads filled in the step (b) have already been prefoamed and cured.

In above method, bottom case and top cover are both made of PVC, HIPS, PET, PC or ABS by plastic-absorbing process.

In above method, in the steps (c) and (d), the heating process is implemented by providing water vapor into the mould.

In above method, in the steps (c) and (d), the heating process is implemented by providing water vapor of 100˜120° C. into the mould and heating for 1˜2 minutes.

In above method, in the steps (c) and (d), the cooling process is implemented by water-cooling.

In above method, the cooling process is implemented by water-cooling for 0.5˜1 minutes.

In above method, it includes the step of positioning the bottom case into the mould to form an inner core thereon and then covering with the top cover and fusing the top cover together with the inner core.

To solve above technical problems, the present invention further provides a pallet including an outer casing which is made of HIPS, PVC, PET, PC or ABS. The outer casing includes a bottom case and a top cover assembled with the bottom case. The bottom case has a flat part and a plurality of hollow supporting legs formed by sinking down from the flat part. An inner core made of EPS foams by thermal forming is formed in the outer casing and fused with the inner surface of the bottom case and top cover.

In above pallet, the bottom case extends upward from the circum of the flat part to form a bottom case lateral margin which is perpendicular to the flat part, the top cover extends downward from its circum to form a top cover lateral margin which is perpendicular to the top cover, the inner core protrudes to the bottom case lateral margin, and the under part of the inside of the top cover lateral margin contacts with the upper part of the outside of the bottom case lateral margin.

The beneficial technical effects of the present invention include: because the EPS foam beads can expand and then be fused with the internal surface of the bottom case and top cover at heating condition, the outer casing can combine with the cooling formed inner core closely; compared with the existing EVA glue layer bonding way, it can improve the bond strength of the outer casing and inner core substantially, thereby effectively avoiding such a situation that the outer casing and inner core will detach from each other when the pallet is used, and then ensuring the quality of pallet.

Other aspects, features, and advantages of this invention will become apparent from the following detailed description when taken in conjunction with the accompanying drawings, which are a part of this disclosure and which illustrate, by way of example, principles of this invention.

### BRIEF DESCRIPTION OF THE DRAWINGS

FIG. 1 is a structure schematic diagram illustrating a pallet of the present invention;

FIG. 2 is a section view schematic diagram illustrating a pallet of the present invention;

FIG. 3 is a structure schematic diagram illustrating a bottom case of the pallet of the present invention;

FIG. 4 is a flowchart showing a manufacturing process of a pallet of the present invention.

### DETAILED DESCRIPTION OF THE INVENTION

The following illustration combining the accompanying drawings and embodiments will facilitate a clear understanding of the object, technical solution and advantages of the present invention for an ordinary person skilled in the art.

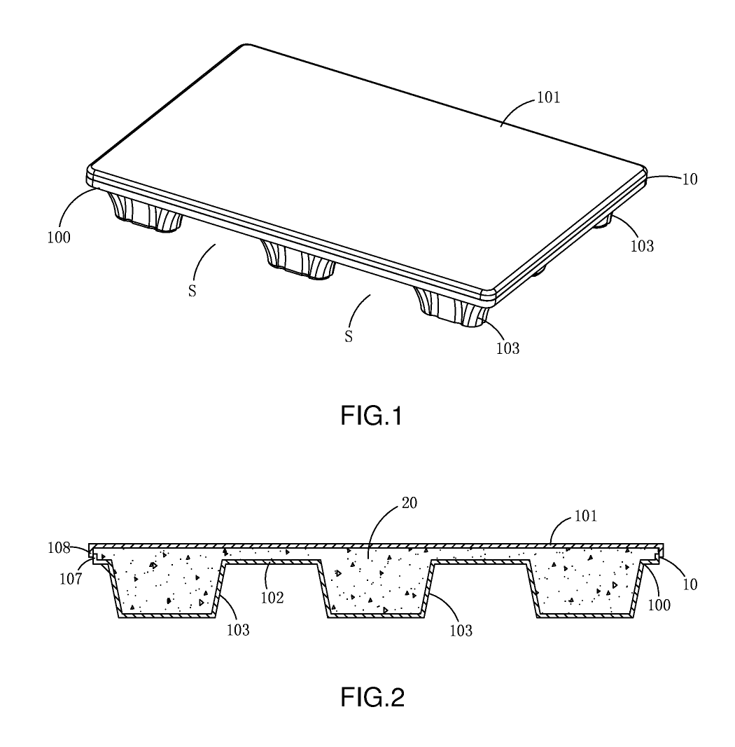

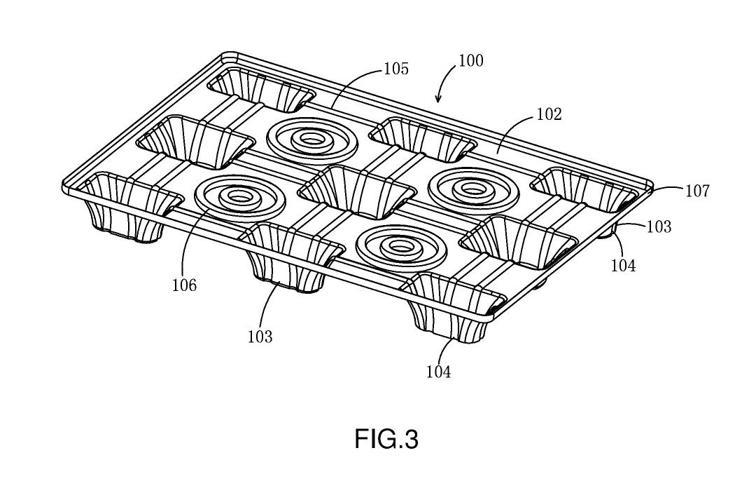

A pallet disclosed by the present invention is a plastic pallet, which is designed to be a rectangular plate with supporting legs. Referring to FIG. 1 to FIG. 3, the pallet includes an outer casing 10 made of polyvinylchloride (PVC) and an inner core 20 made of expandable polystyrene (EPS) foams by foaming and molding into the outer casing 10. The outer casing 10 includes a bottom case 100 and a top cover 101 covering on the bottom case 100. The bottom case 100 has a flat part 102 and a plurality of hollow supporting legs 103 which is formed by sinking down from the flat part 102. The supporting legs 103 are arranged in three columns thereby providing an inserting groove S between each two columns of the supporting legs 103 for being inserted by a wishbone of a forklift, thus it is easy to use a forklift to fork the pallet and then carry or load and unload the goods which are fixed on the pallet.

In an embodiment shown in figures, the bottom case 100 has nine supporting legs 103 formed thereon, which are arranged in three rows and four columns, thereby forming an inserting groove S both between each two rows and each two columns of the supporting legs 103. Thus, in transport/load and unload operation, an operator can handle the forklift to insert into the pallet from four directions and then transport the pallet without considering the way of placement of the pallet, thereby effectively improving the efficiency of transport/load and unload operation of goods.

The EPS foams are foaming and formed with the bottom case 100 and the top cover 101 successively and then forms an inner core 20 after cooling, which is coated by the outer casing 10 composed of the bottom case 100 and the top cover 101. Because the EPS foam beads can expand and then be fused with the internal surface of the bottom case 100 and top cover 101 at heating condition, the outer casing 10 can combine with the cooling formed inner core 20 closely. Compared with the existing EVA glue layer bonding way, it can improve the bond strength of the outer casing 10 and inner core 20 substantially, thereby effectively avoiding such a situation that the outer casing 10 and inner core 20 will detach from each other when the pallet is used, and then ensuring the quality of pallet.

To enhance the structural strength of the pallet, at least one outer side surface of the supporting legs 103 has a notch 104. In this preferable embodiment, four outer side surfaces of each supporting leg all have notches 104 formed thereon, and the notches 104 formed on the two opposite outer side surface are symmetrical.

Preferably, the top surface of the flat part 102 of the bottom case 100 has a straight stiffener 105 formed between two adjacent supporting legs 103 and has a circular stiffener 106 formed among four supporting legs 103. Due to the setting of the above-mentioned straight stiffener 105 and circular stiffener 106, the structural strength of the bottom case 100 can be further enhanced, thereby enhancing the over-all structural strength of the pallet.

Referring to FIG. 2, the bottom case 100 extends upward from the circum of its flat part 102 to form a bottom case lateral margin 107 which is perpendicular to the flat part 102, and the top cover 101 extends downward from its circum to form a top cover lateral margin 108 which is perpendicular to the top cover 101. The inner core 20 protrudes to the bottom case lateral margin 107 of the bottom case 100, the bottom case 100 is covered by the top cover 101 and the under part of the inside of the top cover lateral margin 108 contacts with the upper part of the outside of the bottom case lateral margin 107, thereby increasing the fusion area of the inner core 20 and top cover 101 and then increasing the bond strength of them, meanwhile, it also ensures that the inner core 20 is coated by the outer casing 10 totally. Generally, the height of the bottom case lateral margin 107 is designed to be 1˜3 cm, the inner core 20 protrudes for 1˜3 cm, and the height of the top cover lateral margin 108 is designed to be 3˜5 cm.

In above-mentioned embodiment, the bottom case 100 and top cover 101 which constitute the outer casing 10 are made of PVC materials, however, in other embodiments, they also can be made of high impact polystyrene (HIPS), polyethylene terephthalate (PET), polycarbonate (PC) or acrylonitrile butadiene styrene (ABS). In view of the factors including product rigidity, easy mouldability, cost and environment friendly, using PVC or ABS materials to make the outer casing 10 of the present invention is preferable.

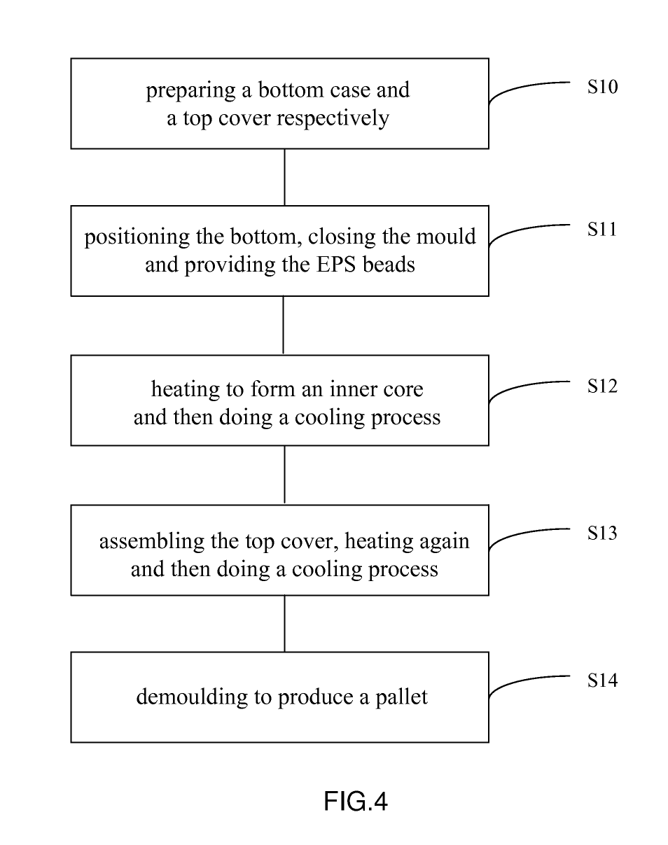

A pallet manufacturing process disclosed by the present invention will be illustrated by combining with FIG. 4 as follows.

First, preparing a bottom case 100 and a top cover 101 respectively (step S10). The bottom case 100 and top cover 101 can be made of PVC, HIPS, PET, PC or ABS by plastic-absorbing process, and preferably use PVC or ABS materials.

Positioning the bottom case 100 into a mould of EPS foams molding machine, closing the mould and filling the mould cavity of the mould with EPS beads (step S11). In this step, can use a venture device, such as a filling material gun, to blow the EPS beads into the mould cavity of the mould so as to fill with the mould cavity. Preferably, the EPS beads have already been prefoamed and cured.

Heating to make the EPS beads expand to form an inner core 20 and is fused with the internal surface of the bottom case 100 and then doing a cooling process (step S12). In this step, may provide water vapor of 100˜120° C. into the mould and heat for 1˜2 minutes so as to heat the EPS beads therein to make them expand to fill the gap between each other and bond to each other to form an uniform inner core 20, and bond to the internal surface of the bottom case 100 simultaneously. The mould generally adopts a double wall mould, which has a steam room formed by the space between the double walls. Its inner wall has pores formed thereon and water vapor with high temperature is provided into the space between the double walls and enters the mould cavity via the pores to heat the EPS beads therein. After the inner core 20 molded by thermal molding, carry on water-cooling for 0.5˜1 minutes to make the shape of inner core 20 stable.

Opening the mould, positioning the top cover 101 onto the bottom case 100, closing the mould and heating to make the EPS beads expand again so as to be fused with the top cover 101, and then carry on a cooling process (step S13). In this step, may provide water vapor of 100˜120° C. into the mould and heat for 1˜2 minutes, and in the later cooling step, cool the water for 1˜2 minutes.

At last, demoulding to produce a pallet (step 14).

In above-mentioned step S12 of making the inner core 20, the manufactured inner core 20 bulges out over the upper end of the bottom case lateral margin 107 of the bottom case 100 for 1˜3 cm, thus, in the step S13, the protruding part of the inner core 20 may bond with the internal side face of the top cover lateral margin 108 of the top cover 101 so as to ensure the bond strength of the top cover 101 and inner core 20.

In the embodiment shown in FIG. 5, the inner core 20 is made onto the bottom case 100 first and then the top cover 101 is assembled onto the inner core 20. For an ordinary person skilled in the art, it is understandable that in other embodiments, the inner core 20 may be made onto the top cover 101 first and then the bottom case 100 is assembled onto the inner core 20.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A method for manufacturing a pallet, the method comprising the steps of:
(a) preparing a bottom case and a top cover respectively;
(b) positioning the bottom case and top cover into a mould of an EPS foams moulding machine, closing the mould and filling a mould cavity of the mould with EPS beads;
(c) heating to make the EPS beads expand to form an inner core which is fused with the bottom case or top cover and then doing a cooling process;
(d) opening the mould, positioning the top cover or bottom case onto the bottom case or top cover and closing the mould, heating to make the EPS beads expand again to be fused with the top cover or bottom case, and then doing a cooling process; and
(e) demoulding to produce a pallet.

2. The method as claimed in claim 1, wherein the EPS beads filled in the step (b) have already been prefoamed and cured.

3. The method as claimed in claim 1, wherein the bottom case and top cover are both made of PVC, HIPS, PET, PC or ABS by plastic-absorbing process.

4. The method as claimed in claim 1, wherein in the steps (c) and (d), the heating process is implemented by providing water vapor into the mould.

5. The method as claimed in claim 4, wherein in the steps (c) and (d), the heating process is implemented by providing water vapor of 100˜120° C. into the mould and heating for 1˜2 minutes.

6. The method as claimed in claim 1, wherein in the steps (c) and (d), the cooling process is implemented by water-cooling.

7. The method as claimed in claim 6, wherein the cooling process is implemented by water-cooling for 0.5˜1 minutes.

8. The method as claimed in claim 1, wherein comprises the step of positioning the bottom case into the mould to form an inner core thereon and then covering with the top cover and fusing the top cover together with the inner core.

9. A pallet comprising an outer casing, wherein the outer casing is made of HIPS, PVC, PET, PC or ABS and comprises a bottom case and a top cover assembled with the bottom case, the bottom case has a flat part and a plurality of hollow supporting legs formed by sinking down from the flat part, and an inner core made of EPS foams by thermal forming is formed in the outer casing and fused with the inner surface of the bottom case and top cover.

10. The pallet as claimed in claim 9, wherein the bottom case extends upward from the circum of the flat part to form a bottom case lateral margin which is perpendicular to the flat part, the top cover extends downward from its circum to form a top cover lateral margin which is perpendicular to the top cover, the inner core protrudes to the bottom case lateral margin, and the under part of the inside of the top cover lateral margin contacts with the upper part of the outside of the bottom case lateral margin.
